(19) United States
(12) Patent Application Publication
(10) Pub. No.: US 2012/0023735 A1
(43) Pub. Date: Feb. 2, 2012

(54) METHOD FOR THE PRODUCTION OF EXTRA HEAVY PIPE JOINTS, PREFERABLY FOR OFF-SHORE WIND ENERGY PLANTS

(75) Inventor: Rainer Spreckelmeyer, Osnabrueck (DE)

(73) Assignee: IAG MAGNUM GMBH, Osnabrueck (DE)

(21) Appl. No.: 13/259,461

(22) PCT Filed: Apr. 21, 2010
(86) PCT No.: PCT/DE2010/000448

§ 371 Date: Sep. 23, 2011

(30) Foreign Application Priority Data
Apr. 23, 2009 (DE) 10 2009 018 343.4
Jun. 24, 2009 (DE) 10 2009 030 172.0

(51) Int. Cl. B23P 13/04

(52) U.S. Cl. 29/558

(57) ABSTRACT

The invention relates to a method for producing extra heavy pipe joints used in the off-shore industry, for example. In the method, all cutting processes are performed on planar, sheet metal-like parts, thus dispensing with the need for an expensive flame cutting machine for pipes.

The invention relates to a method for simple, cost-advantageous production of components for extra-heavy pipe framework constructions, pipe constructions, and cone constructions, in offshore wind energy plants.

The support and foundation structures of offshore wind energy plants are generally structured as welded steel constructions or as concrete constructions. A foundation structure made of concrete is described in GB2182375, for example.

A floating mixed construction, in which framework components made of steel are combined with container parts made of concrete, is described in DE 102008003647.

Welded steel constructions are typically structured in the form of a pipe framework or a box structure. A foundation structure as a box construction, consisting of an n-agonal support frame, is the object of the document DE202004020720131.

Because of their constantly curved surface, pipe frameworks have significant advantages with regard to corrosion protection and flow resistance, something that is particularly important in offshore applications. The configuration of the connections of the pipe framework rods with one another is problematical. This connection is almost exclusively practiced by means of welding.

The document EP 2067914 describes a pipe framework construction in the form of a lattice structure. Pipes having a comparatively small diameter are joined together into a symmetrical framework, in such a manner that the geometrical diversity of the connection points, the so-called nodes, is significantly reduced.

The nodes are pre-manufactured and are connected with the attaching pipes by means of simple round seams, at the construction site. With this, the result is achieved that no weld seam runs in the region of the greatest stress within the node. Furthermore, the result is achieved that the weld seams can be produced in automated or at least mechanized manner, by means of orbital welding methods. The nodes themselves are not unique parts, but rather mass production parts, possess joining surfaces and prepared weld pool backings, and can be precisely coordinated with the prevailing forces, in terms of their geometrical shape, their cross-section, and their wall thickness.

It is obvious to produce such nodes as cast constructions. This is proposed in the document DE2519769. Almost any desired number of pipe axes can intersect at a point, without interferences between attaching pipes taking place.

The disadvantage of cast nodes is the low flexibility, in terms of design. Efficient node production is only possible in the case of mass production, because of the required casting model, the lost casting mold, and the comparatively time-consuming production. The nodes cannot be produced on site and must be transported from the foundry to the construction site, thereby limiting their maximal dimensions.

Another possibility of node production is described in GB2205915. A planar metal sheet is first shaped in a matrix, to produce a U shape. Afterwards, it is turned outward in another matrix, using a mandrel, then perforated and cut, forming the rod connector.

A similar solution is also described in EP0195063. In this document, it is pointed out that heat treatment is necessary between every work step. It is furthermore proposed to put the component into the heated state also for part of the work steps.

By means of this method of node production, a constant, low-notch transition from the node into the nozzle connector is made possible. This process is referred to as necking, according to DE1072581.

The force lines in the component are not interrupted; the force flow is not disturbed. The transition region can be configured in conical shape. Even more than in the case of cast nodes, design restrictions are in effect, because specially shaped tools and machines are required for exerting the forming forces. Different tools and mandrels are required for every cutting angle and for every angle connector diameter.

The production of the necking is an activity greatly marked by manual work; mechanization or automation hardly seems possible. Manual adjustment work, on the other hand, is always required. Production becomes all the more difficult, the greater the pipe diameter.

Pipe nodes can be structured as pure weld connections. The starting point is two cylindrical pipe segments, generally having different diameters, which, starting from a certain diameter, are no longer rolled without a seam, but rather produced from a rounded metal sheet that is shaped into a cylinder, a so-called pipe section.

The pipe involved in the connection, which has a smaller diameter, possesses a shape referred to as a penetration contour, intersection contour, or saddle contour, at its end. The calculation of this contour, based on spatial trigonometry, is comparatively simple when using computers, and can also be carried out by any modern CAD system. In general, thermal cutting methods, such as flame cutting or plasma cutting, are used to produce the contour. It is still widespread in the steel-processing industry to guide the flame cutter or plasma cutter manually, in that the saddle contour is scribed or punch marked—in part with the aid of a stencil—and the worker guides the burner along this track manually. Of course, it is not possible to produce a smooth cut flank and a defined chamfer shape in this manner.

The state of the art with regard to production of the saddle contour is the use of a pipe flame cutting machine. The pipe is rotated in this machine by a rotation unit, under program control, and the saddle contour is formed in interaction. With the burner, which is situated in the 12 o'clock position and can be moved along the pipe axis, under program control. High-power pipe flame cutting machines, such as the technical solution that is described in EP18073, for example, allow not only the production of the saddle contour but also the production of a so-called weld seam preparation. This serves to create a V-shaped interstice between the two pipes that are to be connected, which interstice is filled with weld material during installation, and brings about a non-releasable connection of the two pipes, with one an anther, to form a pipe node.

DD266144 describes a method that reverses the method of procedure in the production of a pipe elbow having a great rated width, in such a manner that unrolling of the mantle surface into a plane takes place, the planar section shape is then cut from the metal sheet, and this cut shape is then shaped into a pipe elbow using manual means. Adjustment work is absolutely necessary, since a pipe elbow represents a torus, from a geometrical point of view, and thus a two-dimensionally curved component, which can only be unrolled by approximation. The method ignores sheet-metal thickness and plastic deformation during rolling.

The increasing size of wind energy plants requires foundation structures and support structures having extreme dimensions. Their individual parts are not suitable for road transport, because of their mass and because of their dimensions. Complete processing must take place at one location; all the required machines and systems must be available at this location. This is particularly precarious with regard to production of the saddle contour. Manual production is excluded, because of the dimensions of the components and the quality requirements that are in effect. A pipe flame cutting machine, on the other hand, must be designed for the required pipe diameter; therefore it must be structured with very great effort, and represents a significant cost factor. Pipe flame cutting machines are not suitable for cutting conical components, such as the shafts of offshore and also onshore wind towers, for example.

### TASK OF THE INVENTION

It is the task of the invention to create a method for the production of the components of extra-heavy pipe constructions, which method fulfills the new and very strict requirements of the wind energy industry with regard to fit precision, weld seam quality, notch effect at the connection location, and durability. It is also the task of the invention to increase the efficiency of component production, in that the transport of semi-finished products is simplified or made possible in the first place, production of the components can be implemented using a machine pool that is typically available in a steel processing operation, and use of a pipe flame cutting machine is made obsolete.

### SOLUTION ACCORDING TO THE INVENTION

According to the invention, this task is accomplished in accordance with the characteristics of claim 1.

First, a three-dimensional computer model of the component, including the optimal weld seam preparation, from the aspect of welding technology, at the connection location of two intersecting components, is created. The seam preparation must be structured in such a way that the entire component cross-section is connected with the partner element using a butt seam. For this purpose, one of the partner elements is given a seam preparation shaped as half a V-seam or as a K-seam. Geometrical conditions (diameter ratios, intersection angles of the partner element axes . . . ) might make it necessary, under some circumstances, for the seam preparation to also be carried out toward the inside of a partner element.

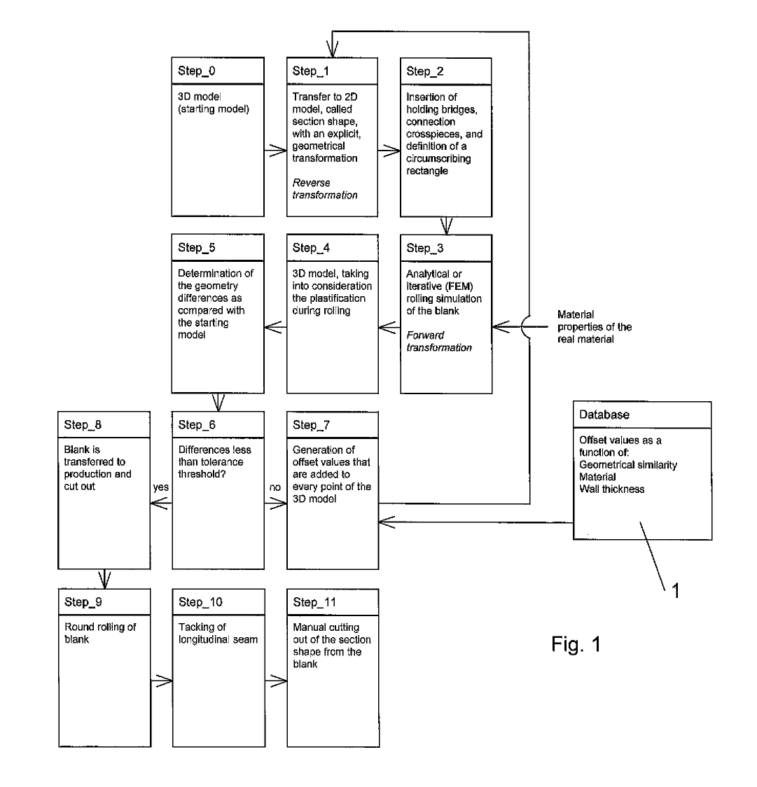

The component, which is present as a 3D model, is transformed, in an iterative process, into a planar, sheet-like component model having cutting flanks with a variable chamfer angle, by means of geometrical and structure-mechanical calculations and with knowledge of the course of the rolling process. For this purpose, the 3D model (Step_0) according to FIG. 1 is first transformed into a 2D model, called a section shape, with an explicit geometrical transformation, in the manner of a reverse transformation (Step_1). Reverse transformation means that the transformation direction runs opposite to the production sequence. Consequently, here, forward transformation is understood to mean that the transformation direction is identical with the production flow.

The section shape is a planar component, having cut flanks that do not, however, run perpendicular to the component plane, and result from the chamfer angle progression of the cut contour or the 3D model from Step_0. However, the section shape at first does not take into consideration the influence of plastification of the material during rolling.

A circumscribing rectangle around this component model is found, and the component model is anchored to it with holding bridges and connection crosspieces, and, at the same time, the residual material contained in possible cutouts and holes of the 3D model is connected with the section shape in the same manner (Step_2). A rectangular sheet-metal part called a blank is formed, having at least one cut contour closed in itself, interrupted by holding crosspieces and connection bridges.

On the basis of the material properties of the steel batch used for the component, which are preferably obtained using a tensile test, and using mathematical methods, for example the widespread method of finite elements (FEM), the blank, taking into consideration the parameters of rolling technology, such as use of a three-roller or four-roller bending machine or a polygonal edging procedure,

roller diameter and edging radius, respectively,
number of rolling steps,
roller adjustment,
. . . ,
is calculated backward, as a forward transformation (Step_3), to produce a three-dimensional model (Step_4), and the geometrical differences between this model and the 3D model from Step_0 are determined (Step_5). If the geometry difference between the model from Step_0 and the one from Step_4 is less than a geometry tolerance that is usual in the industry, which can lie between 1 . . . 3 mm, according to experience, the iteration process can be stopped and the blank from Step_2 can be transferred to a machine program and cut out (Step_8). Afterwards, the blank is rolled into its three-dimensional shape, which is usually a cylinder, but can also be a cone (Step_9). The blank is then tacked in its longitudinal direction (Step_10). Manually, in a final technology step, the section shape is separated by means of cutting open the connection crosspieces and holding bridges (Step_11), followed by the usual further processing using welding technology.

In the opposite case, offset values are obtained using methods of numerical mathematics, such as the Regula Falsi method, which values are added to every point of the cut contour of the section shape from Step_1 (Step_7). The iteration process starts again with Step_2.

In the current state of the art, the calculation process in Step_3, the forward transformation, is extremely calculation-intensive, requires a computer power that goes far beyond the usual performance capacity of a personal computer, and furthermore requires computing times on the order of hours. This is very obstructive for a practical application.

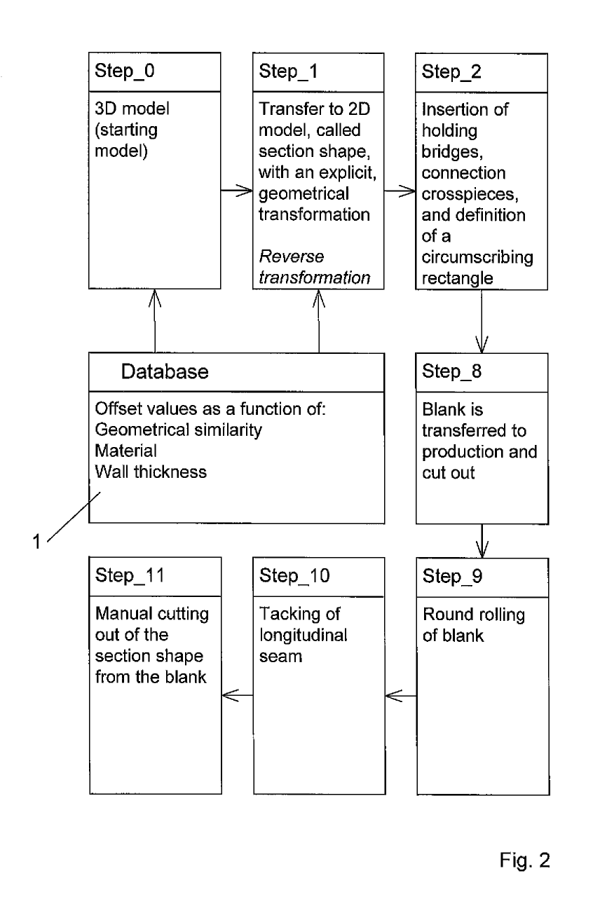

For this reason, it is furthermore proposed to create a database that is filled not only with the results of the mathematical calculations just described but also with empirical values and experimental results from the practical application of rolling, and is constantly updated and improved with new and improved data material. Based on geometrical similarity, wall thickness, two-dimensional expanse and bending radius of the section shape, offset values that were inter-interpolated in the database, using mathematical methods, for a refinement of the values, can be obtained from the database and added to the section shape in Step_1, and can shorten the iteration described in FIG. 1 (Step_2 to Step_7), by reducing the number of iteration steps, or actually make it superfluous. The database is created offline, in other words before industrial use of the method, and only offset values are called up from it online, during ongoing use in industrial practice, and optionally added to the 3D model itself or to the section shape calculated from the 3D model, with explicit geometrical transformation. This results in a simplified calculation process according to FIG. 2, which saves time and costs.

### OVERVIEW OF THE REFERENCE SYMBOLS USED

1—database
2—mast segment
3—shroud
4—longitudinal weld seam
5—shroud opening
6—three-dimensional cut flank
7—cylindrically shaped sheet-metal segment
8—two-dimensional sheet-metal segment
9—transformed cut flank
10—connection crosspieces
11—scrap part
12—main part
13
14—nozzle pipe
15—person
16—weld seam preparation
17—reversal point
18—plate-shaped part
19—cut flank
20—rectangular sheet-metal segment
21—pipe axis
22—round seam

### Configuration of the Invention on the Basis of Exemplary Embodiments

The further configuration of the invention will now be explained further using the exemplary embodiments listed below.

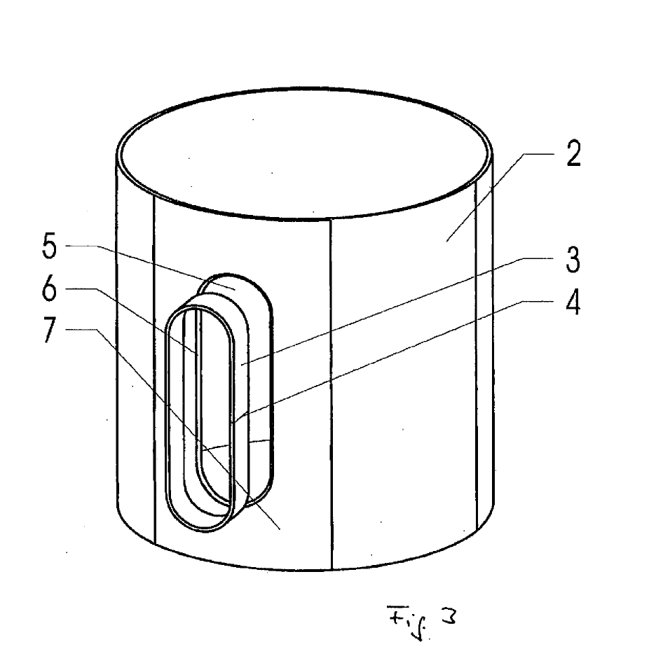

A first exemplary embodiment, in accordance with FIG. 3, shows a penetration between a conical mast segment 2 of a wind energy plant and a partially thick-walled oval shroud 3. The shroud 3 encloses a door opening and balances out the weakening of the mast segment cross-section. The shroud 3 is an oval rolled from sheet metal, closed off with a longitudinal weld seam 4, and possesses significant tolerances by its nature. The shroud 3 is pushed into the shroud opening 5 of the mast segment 2, and then connected with the latter with material fit, by means of welding.

The welding of the shroud 3 to the mast segment 2 takes place by means of a butt seam, which is configured as an HV seam between the shroud 3 and the shroud opening 5 on the mast segment 2 that is produced for the shroud 3. For this purpose, a three-dimensional cut flank 6 is formed on the opening of the mast segment 2.

The conventional production sequence consists in rolling the mast segment, tracing the projected shroud shape on the segment, and cutting it out and preparing for the seam, using manual working methods. Of course, the fit precision is low, and the time required for this is great. The use of industrial robots for cutting out the shroud opening 5 cannot be implemented for reasons of accessibility, the existing tolerances, and the rough production surroundings.

In contrast, in accordance with the method of procedure described above, the real cross-sectional shape of the shroud 3 is measured, modeled in the CAD system as a planar contour, placed on the cylindrical or conical segment, and the penetration, including the seam preparation, is calculated. This process step can be carried out easily and quickly. The mast segment 2 possesses such a great diameter that it is generally not made of a single metal sheet, but rather joined together from a larger number of metal sheets, using longitudinal seams 4 and round seams 22. The shroud opening 5 should be placed on the mast segment in such a manner that it is completely enclosed by a metal sheet, in order to avoid seam intersections.

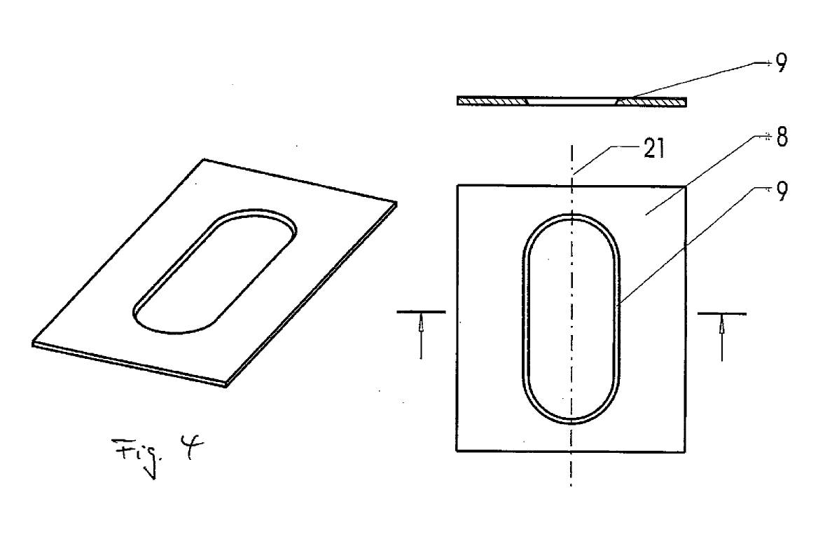

This segment is transformed, according to FIG. 4, into a planar part, the two-dimensional sheet-metal segment 8, containing a transformed cut flank 9, by means of an explicit geometrical transformation.

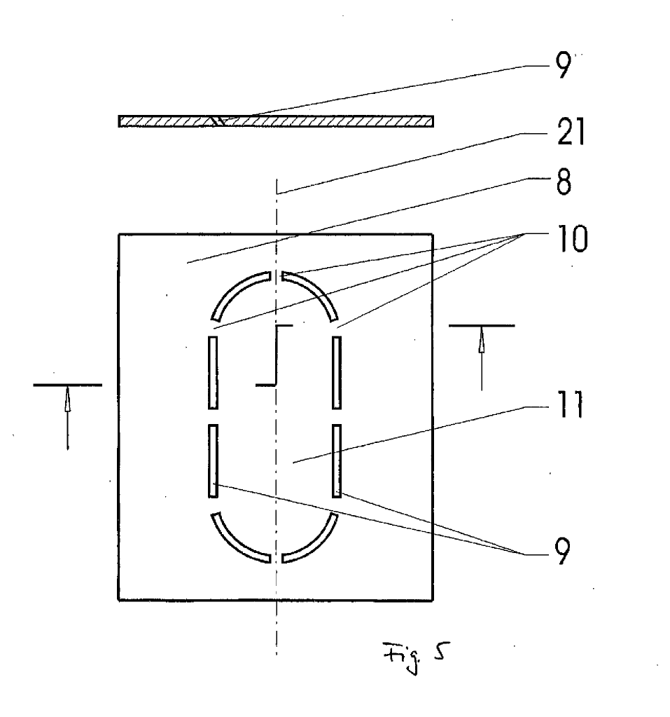

The two-dimensional sheet-metal segment 8 is provided with connection crosspieces 10, according to FIG. 5, in such a manner that the scrap part 11 remains connected with the two-dimensional sheet-metal segment 8. The connection crosspieces 10 are preferably inserted at the locations of the transformed cut flank 9, where the equivalent stresses that occur during bending form a maximum.

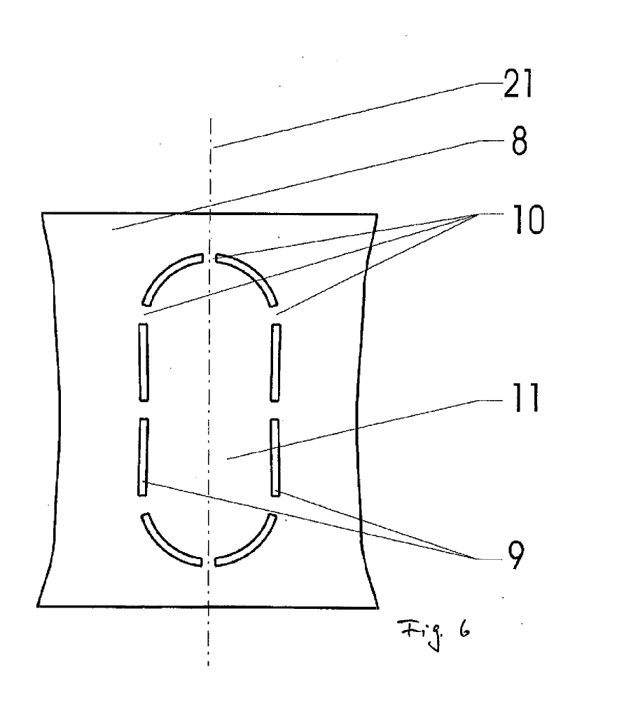

Geometric offset values, which compensate the effects of plastic deformation during rolling, are obtained from the database 1. These values are applied to the planar component, and thereby distort its ideal geometrical shape, as indicated in FIG. 6, in a purely qualitative form and in a great exaggeration, in terms of scale. The segment is then formed into a shell, something that can be done in a three-roller or four-roller bending machine, in an edging machine, or also in a forging die, whereby the forming process must correspond to the defaults of the database, in terms of method and sequence (type of machine used, degree of adjustment, roller diameter, . . . ).

In a final production step, after the forming process, the connection crosspieces 10 are opened manually, for example using an angle grinder or a manual cutting torch, and finished and polished, if necessary.

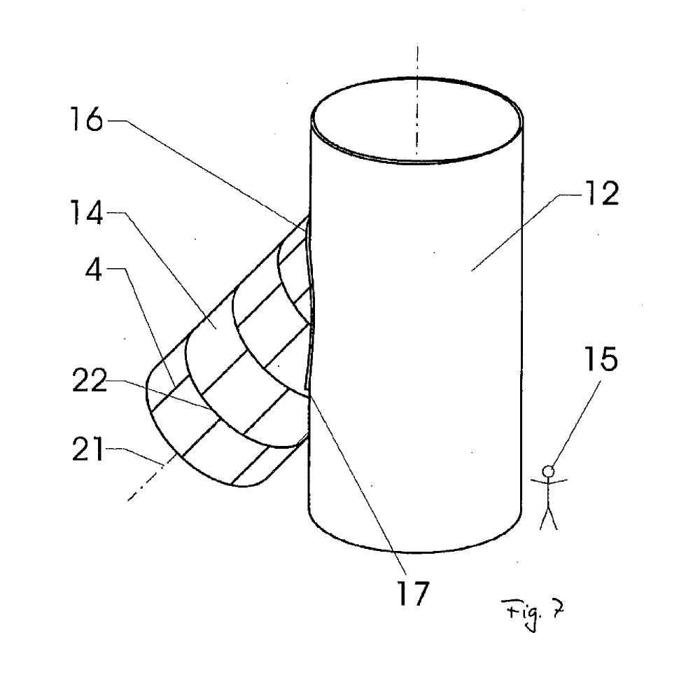

A second exemplary embodiment, according to FIG. 7, shows the production of an extra-heavy pipe node as a connection of two pipes having a very great diameter. To make this clear, an adult person 15 is shown in FIG. 7. In this connection, the usual method of procedure in steel construction consists in leaving the pipe that is larger in diameter, of the two pipes involved in the pipe node, the main pipe 12, in its original state, while the smaller of the two pipes, nozzle pipe 14, is trimmed in the sense of a Boolean “difference” operation and then set onto the main pipe 12 for installation. The connection of main pipe 12 and nozzle pipe 14 is made by means of welding, for which purpose a weld seam preparation 16 for a butt seam is affixed to the nozzle pipe 14. In the region of the obtuse angle enclosed by the two pipes, the main pipe 12 and the nozzle pipe 14, the weld seam preparation lies on the outside of the nozzle pipe 14 and makes a transition to the inside of the nozzle pipe 14 at the reversal point 17. Designing of the connector of the nozzle pipe 14 to the main pipe 12, including the weld seam preparation 16 that jumps from the pipe outside to the pipe inside at the reversal point 17, is carried out quickly and easily using special, geometrically based software, but can also be determined, point by point, in a three-dimensional CAD system, although this is extremely time-consuming.

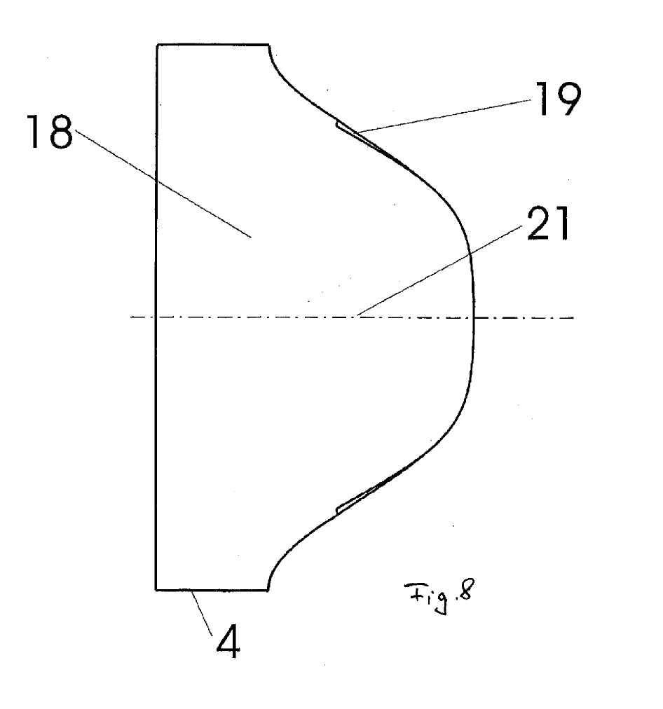

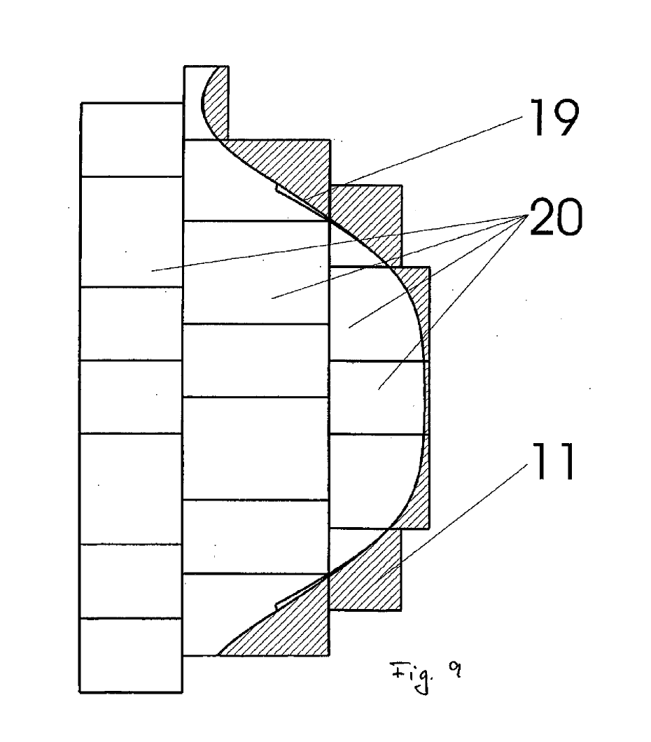

In a subsequent step, according to FIG. 8, the mantle surface of the nozzle pipe 14 is transformed, in an explicit geometrical transformation, into a plate-shaped part 18 having non-planar cut flanks 19. Because of the large dimensions of the nozzle pipe 14, the place-shaped part 18 cannot be produced from a single metal sheet, but rather must be produced from a plurality of rectangular sheet-metal segments 20. For this purpose, according to FIG. 9, the sheet-metal segments 20 must be disposed on the plate-shaped part 18 in such a manner that two edges of the sheet-metal segments 20 are parallel to the pipe axis 21. They must also be disposed in such a manner that seam intersections are avoided. The cut flank 19 should fit into the individual sheet-metal segments 20 in such a manner that it intersects two opposite edges of the sheet-metal segments 20, in each instance, but nevertheless the amount proportion of the scrap material remains minimal.

For each sheet-metal segment 20, offset values are obtained from the database 1 and added to the points of the out flank 19. This is done at least for the four corner points of each sheet-metal segment 20. The offset value of the points of the cut flank 19, without parameters explicitly obtained from the database 1, is interpolated on the basis of adjacent offset values, in linear manner or with a spline. The offset values distort the rectangular shape of each sheet-metal segment 20, but only to a degree that is small in comparison with the dimensions of the sheet-metal segment 20. The division of the sheet-metal segments 20 that contain parts of the cut flank 19, by the same, is cancelled out by means of the insertion of connection crosspieces 10, in such a manner that these are inserted at the locations of the greatest equivalent stress. They are also inserted in the region of the outer contour of each sheet-metal segment 20, in such a form that the outer contour is not interrupted. The data, which were manipulated entirely on a computer workstation up to that point, are transmitted to a cutting machine in the next step, in a standardized data format, for example the DSTV format (standard description of steel construction parts for NC control [XNC]. Recommendations of the DSTV working committee IT, 9^{th} edition, November 2006), and cut out. The cutting machine must possess at least four numerically controlled axes, two of them for orientation of the burner. Once the sheet-metal segments 20 have been cut out, they are rolled to the radius of the nozzle pipe 14, whereby the rolling must take place in accordance with the defaults of the database 1, with regard to the rolling machines used and their parameters (roller diameter, roller adjustment, . . . ). Afterwards, the rolled sheet-metal segments 20 are connected with one another using longitudinal seams 4 and round seams 22, to form the nozzle pipe 14, and the latter is connected with the main pipe 12 along the weld seam preparation 16.

### Advantages of the Solution According to the Invention

The advantages of the solution according to the invention lie in avoiding the use of a pipe flame cutting machine. This machine is cost-intensive and can hardly be operated efficiently by a container builder or plant builder, particularly if it is designed for the component dimensions being considered here.

Use of a service operation requires transport of the cylindrical pipe sections to the service provider and back to the production operation. The transport expenditures for this are great; under some circumstances, road transport is actually excluded because of the dimensions.

In accordance with the solution according to the invention, only the machines that are necessary for implementation of the components described, in any case, are needed, i.e. a flame cutting machine having a chamfer unit for pivoting the burner, on the one hand, a rolling machine for the production of pipe sections and shells, on the other hand. All the processing steps, from the sheet metal to the finished pipe joint, can be performed at a single location. Adjustment work can be carried out more easily, because only individual, comparatively low-mass and easy to handle shells must be handled during installation, instead of the complete nozzle pipe.

1. Method for the production of an extra-heavy pipe joint composed of two partner elements that intersect with their axes, provided with a cylindrical, conical, or oval mantle surface, a shroud (3), and a mast segment (2) or a main pipe (12) and a support pipe (14), whereby one of the partner elements possesses a cylindrical shape or conical shape and penetration takes place,
wherein
a three-dimensional computer model is created, in which the partner elements are joined in such a manner that they make contact with one another in line shape, circumferentially—with the exception of a root gap—and form a V-shaped interstice having a constant seam opening angle and an amount of at least 40 degrees with the partner element, alternately toward the component outside or component inside, but at the same time, the technological limit of the cutting method with regard to the maximal producible chamfer angle of 45 degrees is not exceeded; wherein each partner element on which the V-shaped interstice is formed is transformed from the three-dimensional computer model, by means of an explicit, geometrical transformation, into a planar, plate-shaped section shape, the plate-shaped part (18) having cut flanks that do not run at a right angle to the sheet-metal surface, in such a manner that the cut flank (19) is present as a list of closely spaced together points that form a track curve by means of interpolation, and an angle that runs in the direction of the normal of the track curve and is measured relative to the surface of the plate-shaped part (18) supplements the list for every point;
wherein offset values for compensating the plastic deformations that occur during rolling or bending are obtained from a database (1) filled with correction values and inter-interpolated for refinement, using suitable mathematical methods, as a function of geometrical similarity, wall thickness, two-dimensional expanse, and bending radius of the plate-shaped part (18), and default values for the bending or rolling process are obtained in that these offset values are added to the contour of the plate-shaped part (18).

2. Method for the production of extra-heavy pipe joints according to claim 1,
wherein
a rectangular shape that circumscribes the plate-shaped part (18) is found, in such a manner that two rectangle sides are parallel to the pipe axis (21).

3. Method for the production of extra-heavy pipe joints according to claim 1, wherein cutting out of the plate-shaped part (18) is carried out using a numerically controlled machine equipped with at least four computer-controlled axes of movement, two of which serve for orienting the burner relative to the perpendicular, wherein the required movement program of the machine is obtained from the point and angle list of the cut flank (19), with the offset values applied, and wherein first, the plate-shaped part (18), then the circumscribing rectangle are cut out from a metal sheet that is larger than the circumscribing rectangle, and a firm connection between the plate-shaped part (18) and the circumscribing rectangle is maintained by means of connection crosspieces (10), and a cutting method is used that produces a cutting interstice that is small enough to be ignored, relative to the sheet-metal thickness.

4. Method for the production of extra-heavy pipe joints according to claim 1, wherein the plate-shaped part (18), together with the circumscribing rectangle firmly connected with it by means of the connection crosspieces (10), is rounded off polygonally, either in a three-roller or a four-roller bending machine or in an edging machine having a very small edging distance, and the sequence of the rounding procedure precisely corresponds to the defaults from the database (1).

5. Method for the production of extra-heavy pipe joints according to claim 1, wherein at a corresponding size of the plate-shaped part (18), this part is broken down into rectangular sheet-metal segments (20), in such a manner that a V-shaped weld seam preparation is produced at the connection edges of the rectangular sheet-metal segments (20), with one another, and the rectangular sheet-metal segments (20) are fitted into the plate-shaped part (18) in such a manner that the surface of the plate-shaped part (18) is completely covered by these rectangular sheet-metal segments (20), with the exclusion of seam intersections, and an edge of each rectangular sheet-metal segment (20) runs parallel to the pipe axis (21).

6. Method for the production of extra-heavy pipe joints according to claim 1, wherein after bending or rolling, the plate-shaped part (18) that forms the support pipe (12) or parts of it is/are removed from the rectangular sheet-metal segment(s) (20), wherein the connection crosspieces (10) are eliminated, and the part is connected with the main pipe (12) by means of welding.
